(19) United States
(12) Patent Application Publication
(10) Pub. No.: US 2021/0284116 A1
(43) Pub. Date: Sep. 16, 2021

(54) BRAKE DEVICE

(71) Applicants: TOYOTA JIDOSHA KABUSHIKI KAISHA, Toyota-shi (JP); SUBARU CORPORATION, Tokyo (JP)

(72) Inventors: Nao IKUMA, Anjo-shi (JP); Takeo NANBU, Miyoshi-shi (JP); Tatsuo KIROKU, Shibuya-ku (JP)

(73) Assignees: TOYOTA JIDOSHA KABUSHIKI KAISHA, Toyota-shi (JP); SUBARU CORPORATION, Tokyo (JP)

(21) Appl. No.: 17/161,837

(22) Filed: Jan. 29, 2021

(30) Foreign Application Priority Data
Mar. 16, 2020 (JP) 2020-045119

(51) Int. Cl. B60T 13/58; B60T 7/04; B60T 1/06; B60Q 9/00; B60T 13/14; B60T 13/74; F16D 65/18; B60T 7/12; B60T 8/17

(52) U.S. Cl. CPC B60T 13/58; B60T 7/04; B60T 1/065; B60Q 9/00; F16D 2121/04; B60T 13/746; F16D 65/18; B60T 7/12; B60T 8/17; B60T 13/142

(57) ABSTRACT

A brake device may include: a brake piston configured to press a braking member against a brake member rotating with a wheel; a hydraulic system configured to press the brake piston toward the brake member; an electric-powered system comprising a movable element configured to press the brake piston toward the brake member; and a controller configured to execute a parking brake operation by using the hydraulic system and the electric-powered system. In the parking brake operation, the controller may be configured to apply a pressing force of a predetermined value or greater to the brake piston by using both the hydraulic system and the electric-powered system. The predetermined value may be greater than a maximum pressing force that the electric powered system is capable of applying to the brake piston.

### CROSS-REFERENCE TO RELATED APPLICATION

This application claims priority to Japanese Patent Application No. 2020-045119, filed on Mar. 16, 2020, the entire contents of which are incorporated herein by reference.

### TECHNICAL FIELD

The disclosure herein relates to a brake device for a vehicle.

### BACKGROUND

Japanese Patent Application Publication No. 2006-256578 describes a brake device. This brake device is provided with a brake piston configured to press a braking member against a member to be braked rotating with a wheel, an electric-powered system including a movable element configured to press the brake piston toward the member to be braked, and a controller configured to execute a parking brake operation by using the electric-powered system. The electric-powered system includes a lead screw configured to move the movable element toward and away from the brake piston and a motor configured to rotate the lead screw.

### SUMMARY

The electric-powered system of the brake device of Japanese Patent Application Publication No. 2006-256578 puts and releases a parking brake by rotating the lead screw using the motor. For such a configuration, its motor needs to be selected based on a required braking force, and thus a motor with a relatively large output may be necessary. In general, the size of a motor increases proportional to the output of the motor. As such, if a motor with a relatively large output is employed, the size and weight of brake device is thereby be increased, which may adversely affect vehicle design in various aspects.

In view of the above circumstance, the disclosure herein provides art for reducing an output required for an electric-powered system in a brake device.

A brake device disclosed herein may comprise: a brake piston configured to press a braking member against a member to be braked rotating with a wheel; a hydraulic system configured to press the brake piston toward the member to be braked; an electric-powered system comprising a movable element configured to press the brake piston toward the member to be braked; and a controller configured to execute a parking brake operation by using the hydraulic system and the electric-powered system. In the parking brake operation, the controller may be configured to apply a pressing force of a predetermined value or greater to the brake piston by using both the hydraulic system and the electric-powered system. The predetermined value may be greater than a maximum pressing force that the electric-powered system is capable of applying to the brake piston.

In the above brake device, the parking brake operation is executed by using both the hydraulic system and the electric-powered system. In the parking brake operation, the pressing force of the predetermined value or greater corresponding to a required braking force is applied to the brake piston by both the hydraulic system and the electric-powered system. This predetermined value is greater than the maximum pressing force that the electric-powered system is capable of applying to the brake piston. That is, by using both the electric-powered system and the hydraulic system, a pressing force that cannot be achieved solely by the electric-powered system can be applied to the brake piston. As a result, an output required for the electric-powered system (that is, a motor or another actuator) can be relatively small relative to the braking force required in the parking brake operation. Therefore, the electric-powered system can be relatively small in size, by which the size and weight of the brake device can be reduced and a degree of freedom in vehicle design can be increased.

### BRIEF DESCRIPTION OF DRAWINGS

FIG. 1 shows a block diagram of a brake device 10 of an electric vehicle according to an embodiment.

FIG. 2 shows a circuit structure of a hydraulic system 16 of the brake device 10.

FIG. 3 is a flowchart showing an example of a series of processes related to a parking brake operation executed by the brake device 10.

FIG. 4 is a flowchart showing another example of a series of processes related to the parking brake operation executed by the brake device 10.

FIG. 5 is a flowchart showing an example of a series of processes related to a parking brake release operation executed by the brake device 10.

FIG. 6 is a flowchart showing another example of a series of processes related to the parking brake release operation executed by the brake device 10.

### DETAILED DESCRIPTION

In an embodiment of the art disclosed herein, the electric-powered system may comprise a lead screw configured to move the movable element toward and away from the brake piston and a motor configured to rotate the lead screw. In this case, in the parking brake operation, the controller may be configured to control an operation of the motor. However, the electric-powered system is not limited to the configuration as above. The electric-powered system may have various other configurations so long as it is configured to move the movable element toward and away from the brake piston.

In an embodiment of the art disclosed herein, the hydraulic system may be configured to change the pressing force applied to the brake piston based on an operation performed on a brake pedal by a user. In this case, in the parking brake operation, the controller may be configured to execute a notification process for encouraging the user to further operate the brake pedal based on the pressing three applied to the brake piston by the hydraulic system. That is, in the parking brake operation, the controller may indirectly control the operation of the hydraulic system by way of an operation performed by the user, without directly controlling the hydraulic system. The notification process herein may be a notification perceived by at least one of the sense of vision, the sense of hearing, or the sense of touch of the user, although not particularly limited thereto.

In an embodiment of the art disclosed herein, the hydraulic system may comprise a hydraulic pump configured to increase the pressing force applied to the brake piston. In this case, in the parking brake operation, the controller may be configured to control an operation of the hydraulic pump. With such a configuration, the controller can execute the parking brake operation by directly controlling the operation of the hydraulic system, without having have to particularly require the user to perform an operation.

In an embodiment of the art disclosed herein, the controller may be configured to further execute a parking brake release operation by using the hydraulic system and the electric-powered system. In this case, in the parking brake release operation, the controller may be configured to move the movable element of the electric-powered system away from the brake piston while applying the pressing force to the brake piston by the hydraulic system. In the above-described parking brake operation, the pressing force that cannot be achieved solely by the electric-powered system is applied to the brake piston. Therefore, when the parking brake is to be released, an excessive reaction force is being applied to the movable element from the brake piston, thus the parking brake may not be released solely by the electric-powered system. Due to this, in the parking brake release operation as well, the controller uses both the hydraulic system and the electric-powered system to ensure release of the parking brake. That is, by the controller applying the pressing force to the brake piston using the hydraulic system, the reaction force applied to the movable element from the brake piston is reduced or canceled. By the controller operating the electric-powered system while applying the pressing force to the brake piston by the hydraulic system, the movable element can be surely moved away from the brake piston.

In the above embodiment, the controller may indirectly control the operation of the hydraulic system in the parking brake release operation by way of an operation performed by the user. That is, in the parking brake release operation, the controller may be configured to execute a notification process for encouraging the user to further operate the brake pedal based on the pressing force applied to the brake piston by the hydraulic system. Alternatively, the controller may directly control the operation of the hydraulic system in the parking brake release operation. That is, in the parking brake release operation, the controller may be configured to control the operation of the hydraulic pump of the hydraulic system.

### Embodiments

A brake device 10 of a vehicle according to an embodiment of the art disclosed herein will be described with reference to the drawings. It is envisaged that the brake device 10 of the present embodiment is primarily used in an electric vehicle. However, the configuration described in the present embodiment may not be limited to being used in a brake device for an electric vehicle, but may be used in a brake device for various types of vehicles, such as an engine vehicle.

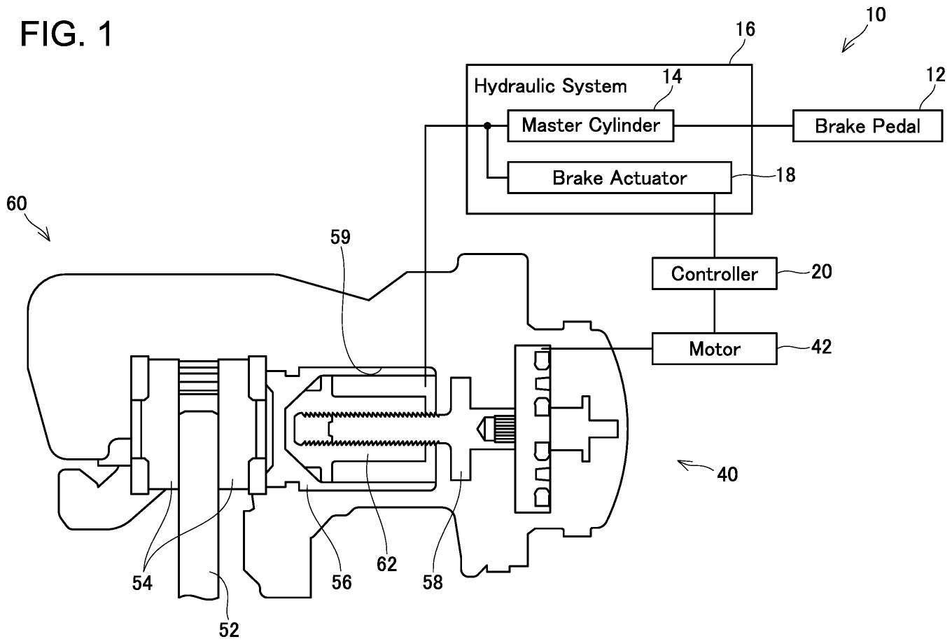

As shown in FIG. 1, the brake device 10 is provided with a member 52 to be braked (hereinbelow termed “braked member”), a braking member 54, and a brake piston 56. The braked member 52 is fixed to be unable to relatively rotate with respect to a wheel and is configured to rotate with the wheel. The braking member 54 is supported to be able to move toward and away from the braked member 52 and is configured to be pressed against the braked member 52 by the brake piston 56. When the braking member 54 is pressed against the braked member 52, a frictional force is generated between the braked member 52 and the braking member 54, by which the braked member 52 (that is, the wheel) is braked.

Although not particularly limited, the braked member 52 is a disc-shaped brake rotor, and the braking member 54 is a pair of brake pads opposed to each other with the brake rotor interposed therebetween. The braking member 54 (that is, the pair of brake pads) is disposed, along with the brake piston 56, on a brake caliper 60. The brake caliper 60 is attached to a suspension (not shown) and includes a cylinder 59 housing the brake piston 56. As above, the brake device 10 of the present embodiment has a disc brake structure. In another embodiment, the brake device 10 may have a drum brake structure. In this case, the braked member 52 may be a brake drum, and the braking member 54 may be one or more brake shoes disposed in the brake drum.

The brake device 10 is provided with a brake pedal 12, a hydraulic system 16, an electric-powered system 40, and a controller 20. The brake pedal 12 is an operation member configured to be operated by a user and is disposed in a driver's seat area of the vehicle. The brake pedal 12 is connected to the brake caliper 60 via a hydraulic circuit including the hydraulic system 16. When the user operates the brake pedal 12, a hydraulic pressure corresponding to how much the brake pedal 12 is operated is transmitted to the brake caliper 60. In the brake caliper 60, the brake piston 56 presses the braking member 54 against the braked member 52. The braked member 52 (that is, the wheel) is thereby braked.

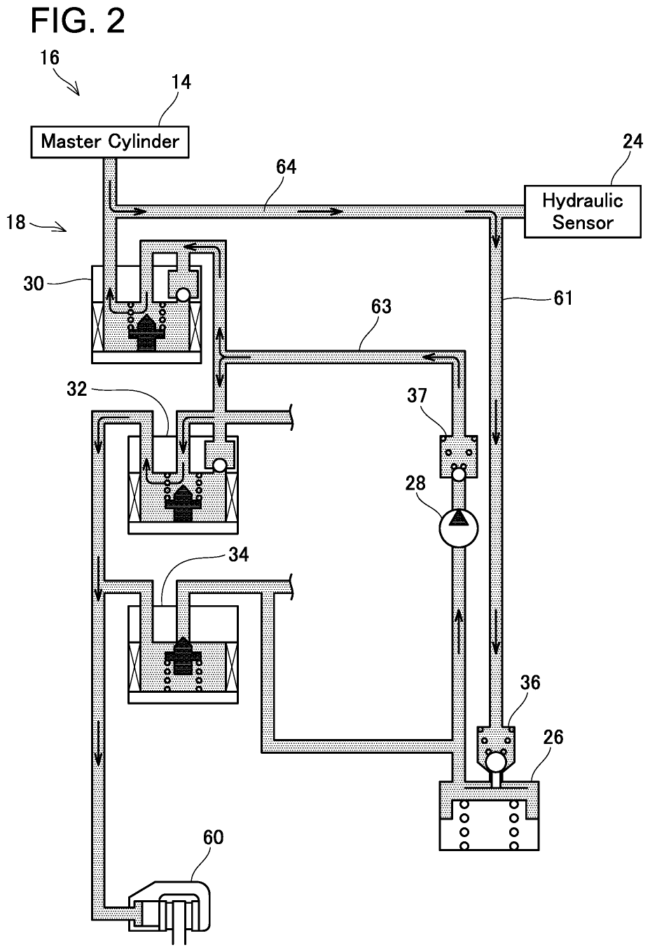

The hydraulic system 16 is not particularly limited regarding its specific configuration. The hydraulic system 16 of the present embodiment includes a master cylinder 14 and a brake actuator 18, although this is merely an example. The master cylinder 14 is a type of brake booster and is interposed between the brake pedal 12 and the brake caliper 60. An operational force applied to the brake pedal 12 is amplified by the master cylinder 14 and then is transmitted to the brake piston 56 of the brake caliper 60. The brake actuator 18 includes a hydraulic pump 28 and the like (see FIG. 2) and is configured to control a hydraulic pressure (that is, braking force) supplied to the brake caliper 60 regardless of the operation performed on the brake pedal 12. An operation of the brake actuator 18 is controlled by the controller 20.

A configuration of the brake actuator 18 will be described with reference to FIG. 2. The configuration described herein is a mere example, and the brake actuator 18 is not limited thereto. As shown in FIG. 2, the brake actuator 18 is provided with a reservoir tank 26, the hydraulic pump 28, a hydraulic sensor 24, a plurality of solenoid valves 30, 32, 34, a plurality of check valves 36, 37, a plurality of pipe lines 61, 63, and brake oil 64. FIG. 2 shows the brake actuator 18 for one brake caliper 60 in the vehicle. Although not particularly limited, the brake device 10 of the present embodiment may include a plurality of brake calipers 60, and in this case, it may include the hydraulic system 16 shown in FIG. 2 for each of the brake calipers 60. The plurality of pipe lines 61, 63 includes a first pipe line 61 and a second pipe line 63. The reservoir tank 26 is a container for temporarily storing excess brake oil 64.

The hydraulic sensor 24 is provided on the first pipe line 61 connecting the master cylinder 14 to the reservoir tank 26 and is configured to detect a hydraulic pressure (brake oil pressure) supplied from the master cylinder 14. The hydraulic sensor 24 is not particularly limited regarding its specific configuration. The hydraulic sensor 24 suffices so long as it is configured to directly or indirectly measure the hydraulic pressure in the first pipe line 61. The hydraulic sensor 24 is connected to the controller 20, and a detection result of the hydraulic sensor 24 is inputted to the controller 20. The check valve 36 is provided on the first pipe line 61 between the hydraulic sensor 24 and the reservoir tank 26. This check valve 36 prohibits a direct flow of the brake oil 64 from the master cylinder 14 to the reservoir tank 26.

The plurality of solenoid valves 30, 32, 34 includes a first solenoid valve 30, a second solenoid valve 32, and a third solenoid valve 34. Each of the solenoid valves 30, 32, and 34 is controlled by the controller 20. The first solenoid valve 30 and the second solenoid valve 32 are of normally-open type, that is, they are usually open but closes when electric power is supplied. The third solenoid valve 34 is of normally-closed type, that is, it is usually closed but opens when electric power is supplied. The first solenoid valve 30 and the second solenoid valve 32 are provided, between the master cylinder 14 and the brake caliper 60, and the third solenoid valve 34 is provided between the brake caliper 60 and the reservoir tank 26. Normally, the first solenoid valve 30 and the second solenoid valve 32 are open and the third solenoid valve 34 is closed. In this state, the hydraulic pressure in the master cylinder 14 is transmitted to the brake piston 56 of the brake caliper 60.

The hydraulic pump 28 is provided on the second pipe line 63 extending from the reservoir tank 26 and is connected to the brake caliper 60 via the second solenoid valve 32. The check valve 37 is provided downstream of the hydraulic pump 28. This check valve 37 prohibits a flow of the brake oil 64 from the master cylinder 14 to the reservoir tank 26 through the hydraulic pump 28 while the hydraulic pump 28 is not operating. An operation of the hydraulic pump 28 is controlled by the controller 20. By controlling the hydraulic pump 28, the controller 20 can supply a desired hydraulic pressure to the brake caliper 60 regardless of the operation on the brake pedal 12 by the user. In this case, the controller 20 closes the first solenoid valve 30 and actuates the hydraulic pump 28. When decreasing the pressure afterward, the controller 20 stops the hydraulic pump 28 and opens the first solenoid valve 30 and the third solenoid valve 34.

Returning to FIG. 1, the electric-powered system 40 is provided with a movable element 62, a lead screw 58, and a motor 42. The movable element 62 is configured to move toward and away from the brake piston 56. Although not particularly limited, the movable element 62 is a nut-shaped member and includes internal threads configured to engage with the lead screw 58. The lead screw 58 is configured to move the movable element 62 toward and away from the brake piston 56 and is configured to be rotated by the motor 42. When the motor 42 rotates the lead screw 58, the movable element 62 is moved toward or away from the brake piston 56. In this way, the movable element 65 can press the brake piston 56 against the braking member 54, as a result of which the braking member 54 is pressed against the braked member 52. Since pitches of threads of the lead screw 58 are sufficiently small, the movable element 62 is not be moved even when a reaction force is applied to the movable element 62 from the brake piston 56. An operation of the electric-powered system 40, especially an operation of the motor 42 is controlled by the controller 20. The configuration of the electric-powered system 40 described herein is a mere example. The electric-powered system 40 is not limited to the configuration as above, and may be configured in various ways so long as it is configured to move the movable element 62 toward and away from the brake piston 56.

The controller 20 is configured to execute a parking brake operation and a parking brake release operation by controlling the operations of the electric-powered system 40 and the hydraulic system 16. Apparently, the parking brake operation is an operation to put the parking brake on the vehicle, and the parking brake release operation is an operation to release the parking brake from the vehicle. In the parking brake operation, a pressing force of a predetermined value or greater corresponding to a required braking force is applied to the brake piston 56 from both the hydraulic system 16 and the electric powered system 40. This predetermined value is greater than a maximum pressing force which the electric-powered system 40 is capable of applying to the brake piston 56. That is, by using both the electric-powered system 40 and the hydraulic system 16, a pressing force that cannot be achieved solely by the electric-powered system 40 can be applied to the brake piston 56. As a result, an output required flit the electric-powered system 40 (that is, the motor 42 or another actuator) can be relatively small relative to the braking force required in the parking brake operation. Therefore, the electric-powered system 40 can be relatively small in size, by which the size and weight of the brake device 10 can be reduced and a degree of freedom in vehicle design can be increased.

In the parking brake release operation, the controller 20 moves the movable element 62 of the electric-powered system 40 away from the brake piston 56 while applying the pressing force on the brake piston 56 using the hydraulic system 16. In the above-described parking brake operation, the pressing force that cannot be achieved solely by the electric-powered system 40 is applied to the brake piston 56. Due to this, a great reaction three is applied to the brake piston 56, thus the parking brake may not be released solely by the electric-powered system 40 when the parking brake is to be released. Therefore, in the parking brake release operation as well, the controller 20 uses both the hydraulic system 16 and the electric-powered system 40 to ensure release of the parking brake. That is, by the controller 20 applying the pressing force to the brake piston 56 using the hydraulic system 16, the reaction force applied to the movable element 62 from the brake piston 56 is reduced or canceled. By the controller 20 operating the electric-powered system 40 while applying the pressing force to the brake piston 56 using the hydraulic system 16, the movable element 62 can be surely moved away from the brake piston 56.

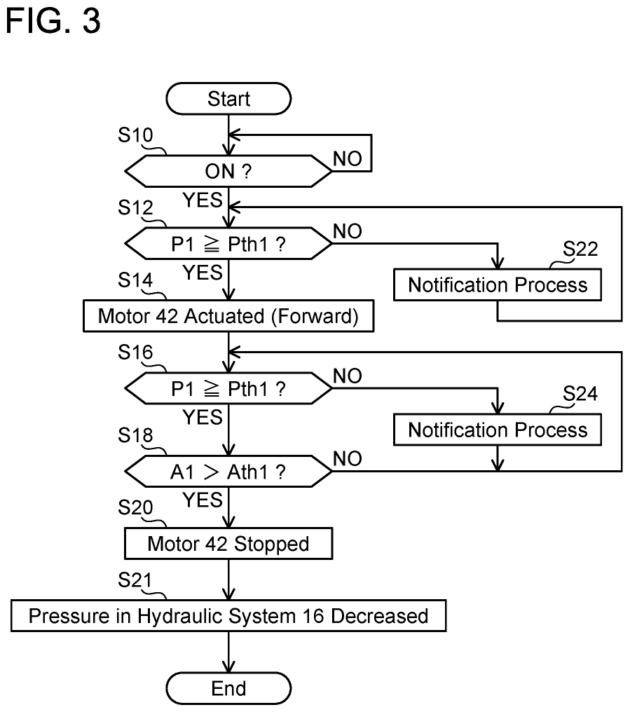

An example of the parking brake operation will be described with reference to FIG. 3. The process of FIG. 3 is initiated in response to the user performing a predetermined operation to set the parking brake operation to ON (YES in step S10). Firstly, in step S12, the controller 20 compares a detected pressure P1 detected by the hydraulic sensor 24 with a predetermined first pressure threshold Pth1. The detected pressure P1 at this time is dependent on the operation on the brake pedal 12 by the user. The first pressure threshold Pth1 is a value that is determined based on a required pressing force to be applied to the brake piston 56 for the parking brake. That is, the detected pressure P1 reaching (being equal to or greater than) the first pressure threshold Pth1 means that a total of the pressing force on the brake piston 56 by the hydraulic system 16 and the pressing force on the brake piston 56 by the electric-powered system 40 is equal to or greater than the pressing force required for the parking brake. At this time, the pressing force on the brake piston 56 by the electric-powered system 40 may be sufficiently smaller than the pressing force on the brake piston 56 by the hydraulic system 16. The first pressure threshold Pth1 is stored in the controller 20 in advance.

The controller 20 proceeds to step S14 if determining that the detected pressure P1 is equal to or greater than the first pressure threshold Pth1 (YES in step S12). On the other hand, the controller 20 determines that the hydraulic pressure is insufficient if determining that the detected pressure P1 is less than the first pressure threshold Pth1 (NO in step S12), and proceeds to step S22. In step S22, the controller 20 executes a notification process to the user. This notification process is executed to encourage the user to further operate the brake pedal 12 (that is, to push the brake pedal 12 harder). After having executed the notification process, the controller 20 returns to step S12.

The above-described notification process is not particularly limited regarding its specific aspects. The notification process may be a notification perceived by at least one of the sense of vision, the sense of hearing, or the sense of touch of the user. Examples of the notification perceived by the sense of vision of the user include lighting a predetermined lamp, displaying a predetermined message and/or a predetermined sign on a display, etc. Examples of the notification perceived by the sense of hearing of the user includes outputting a predetermined alarm sound and/or a predetermined audio message and the like. Examples of the notification perceived by the sense of touch of the user include vibrating an operation member such as a steering wheel or the brake pedal 12, and the like.

In step S14, the controller 20 controls the motor 42 of the electric-powered system 40 to rotate forward. As a result, the lead screw 58 is rotated forward and the movable element 62 is moved toward the brake piston 56. At this time, the brake piston 56 has already been pressed against the braking member 54 by the hydraulic pressure, and thus it is separated from the movable element 62 in front of the movable element 62. As such, a load on the motor 42 is small. In other words, a motor with a relatively small output is sufficient as the motor 42. Next, the controller 20 proceeds to step S16.

In step S16, the controller 20 again compares the detected pressure P1 with the first pressure threshold Pth1. If the detected pressure P1 is equal to or greater than the first pressure threshold Pth1 (YES in step S16), the controller 20 determines that the parking brake operation can be continued and proceeds to step S18. On the other hand, if the detected pressure P1 is less than the first pressure threshold Pth1 (NO in step S16), the controller 20 determines that the operation on the brake pedal 12 by the user is insufficient and proceeds to step S24. In step S24, the controller 20 executes a notification process to the user. This notification process is the same as the above-described notification process of step S22, and is for encouraging the user to further operate the brake pedal 12. After executing the notification process, the controller 20 returns to step S16.

In step S18, the controller 20 compares a current A1 of the motor 42 with a first current threshold Ath1. Based on this, the controller 20 determines whether or not the movable element 62 has come into contact with the brake piston 56. That is, when the movable element 62 contacts the brake piston 56 and the motor 42 is thereby locked, the current A1 of the motor 42 increases significantly. As such, the controller 20 can determine that the movable element 62 has come into contact with the brake piston 56 when the current A1 of the motor 42 exceeds the first current threshold Ath1. The controller 20 proceeds to step S20 if the current A1 of the motor 42 exceeds the first current threshold Ath1 (YES in step S18). On the other hand, the controller 20 returns to step S16 if the current A1 of the motor 42 is below the first current threshold Ath1 (NO in step S18). That is, the comparison step of the detected pressure P1 in step S16 and the comparison step of the current A1 in step S18 are executed again. The determination whether the movable element 62 has come into contact with the brake piston 56 may be made based on indexes other than the current A1 of the motor 42.

As can be understood from the foregoing description, in the parking brake operation shown in FIG. 3, the pressing force required for the parking brake is applied from the hydraulic system 16 to the brake piston 56 by the user operating the brake pedal 12. As such, during the parking brake operation (in steps from step S12), the user needs to keep pushing the brake pedal 12 to keep generating the hydraulic pressure equal to or greater than the first pressure threshold Pth1. Thus, while executing the parking brake operation, the controller 20 continuously monitors the detected pressure P1, and encourages the user to further operate the brake pedal 12 by executing the above-described notification process when needed. As above, in the parking brake operation shown in FIG. 3, the controller 20 does not directly control the operation of the hydraulic system 16 but indirectly controls the operation of the hydraulic system 16 by way of the operation performed by the user.

In step S20, the controller 20 stops the motor 42. As a result, positions of the movable element 62 and the brake piston 56 are locked with the sufficient pressing force applied to the brake piston 56. Then, in step S21, the operation on the brake pedal 12 by the user is released, by which the pressure in the hydraulic system 16 is decreased. At this time, the controller 20 may encourage the user to release the operation on the brake pedal 12 by notifying the user that the parking brake operation has been completed. After this, the parking brake operation is terminated.

In the above parking brake operation, the actuation of the motor 42 (step S14) may be started immediately after the parking brake operation was set to ON and may be executed in parallel to the first pressure comparison (step S12). Further, the pressure decrease in the hydraulic system 16 (step S21) may be executed simultaneously with the stopping of the motor 42 (step S20). Alternatively, the motor 42 may be stopped (step S20) after the pressure in the hydraulic system 16 has been decreased (that is, after step S21).

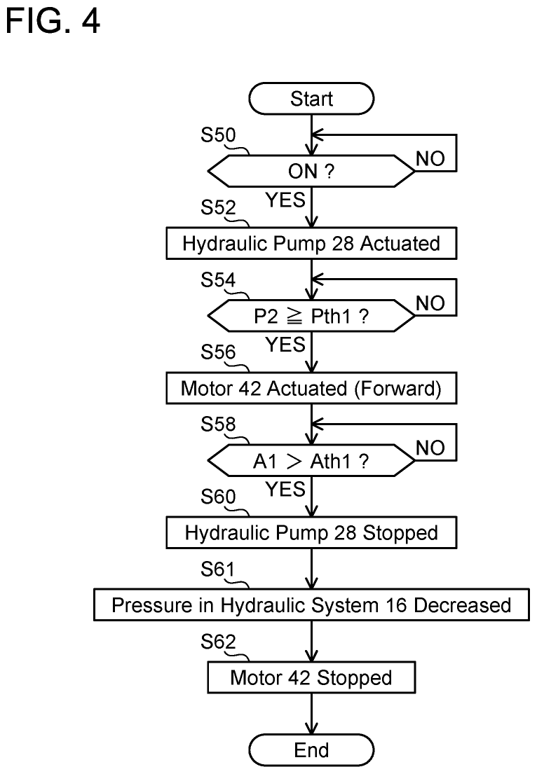

Next, another example of the parking brake operation will be described with reference to FIG. 4. The process of FIG. 4 is initiated in response to the user performing the predetermined operation to set the parking brake operation to ON (YES in step S50). Firstly, in step S52, the controller 20 actuates the hydraulic pump 28 of the hydraulic system 16.

Then, in step S54, the controller 20 compares a pump pressure P2 with the predetermined first pressure threshold Pth1. The pump pressure P2 at this time is a pressure supplied to the brake caliper 60 by the hydraulic pump 28 being actuated. Although the pump pressure P2 may be directly detected, it can be estimated based on a rotational speed of the hydraulic pump 28. In any case, the detection of the pump pressure P2 due to the hydraulic pump 28 is not limited to the above aspects, and may be executed directly by a hydraulic sensor (not shown) provided between the hydraulic pump 28 and the brake caliper 60, for example. Alternatively, step S54 may be omitted if it is apparent, in terms of the design, that the pump pressure P2 will exceed the first pressure threshold Pth1 by the hydraulic pump 28 being actuated.

If the pump pressure P2 is equal to or greater than the first pressure threshold Pth1 (YES in step S54), the controller 20 determines that the parking brake operation can be continued and proceeds to step S56. On the other hand, if the pump pressure P2 is less than the first pressure threshold Pth1 (NO in step S54), the controller 20 determines that the hydraulic pressure is insufficient and then executes the process of S54 again after a predetermined period of time elapses.

In step S56, the controller 20 controls the motor 42 of the electric-powered system 40 to rotate forward. This process is the same as the above-described process of step S14. That is, the lead screw 58 is rotated forward and the movable element 62 is moved toward the brake piston 56. At this time, the brake piston 56 has already been pressed against the braking member 54 by the hydraulic pressure, and thus it is separated from the movable element 62 in front of the movable element 62.

In step S58, the controller 20 compares the current A1 of the motor 42 with the first current threshold Ath1. This process is the same as the above-described process of step S18. If the current A1 of the motor 42 exceeds the first current threshold Ath1 (YES in step S58), the controller 20 determines that the movable element 62 has come into contact with the brake piston 56 and proceeds to step S60. On the other hand, if the current A1 of the motor 42 is below the first current threshold Ath1 (NO in step S58), the controller 20 determines that the movable element 62 is not in contact with the brake piston 56 and then executes the process of step S58 again after a predetermined period of time elapses. The determination whether the movable element 62 has come into contact with the brake piston 56 may be made based on indexes other than the current A1 of the motor 42.

In step S60, the controller 20 stops the hydraulic pump 28. Then, in step S61, the controller 20 decreases the pressure in the hydraulic system 16 by opening the first solenoid valve 30 and the third solenoid valve 34. After this, in step S62, the controller 20 stops the motor 42. As a result, positions of the movable element 62 and the brake piston 56 are locked with the sufficient pressing force applied to the brake piston 56. After this, the parking brake operation is terminated.

As can be understood from the foregoing description, in the parking brake operation shown in FIG. 4, the pressing force required for the parking brake is applied from the hydraulic system 16 to the brake piston 56 by the controller 20 directly controlling the operation of the hydraulic pump 28. Thus, the parking brake can be put on the vehicle without having have to particularly require the user to perform an operation.

In the above parking brake operation, the actuation of the motor 42 (step S56) may be started immediately after the parking brake operation was set to ON and may be executed in parallel to the pressure comparison (step S54). In addition or alternatively, the motor 42 may be stopped (step S62) simultaneously with or prior to the stopping of the hydraulic pump 28 (step S60).

In the above parking brake operation, the pump pressure P2 may include a pressure generated by the user operating the brake pedal 12. In this case, the operation on the brake pedal 12 by the user is performed prior to the actuation of the hydraulic pump 28. That is, if the hydraulic pressure generated by the user operating the brake pedal 12 is insufficient, the hydraulic pump 28 can supplement the shortfall.

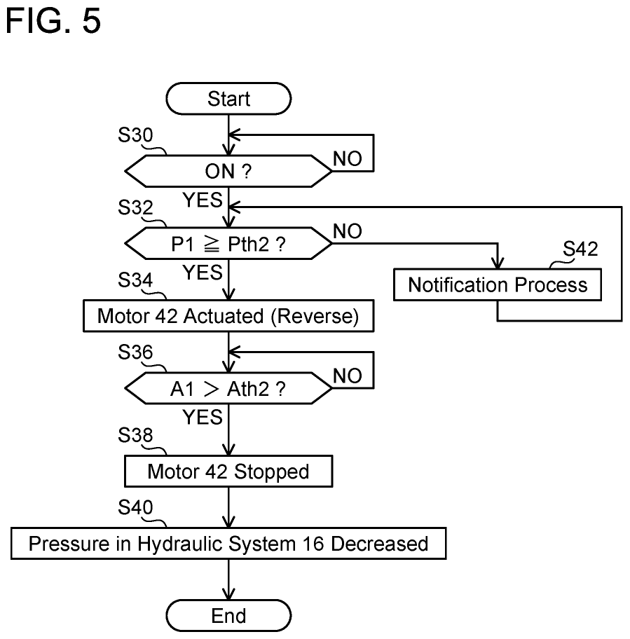

An example of the parking brake release operation will be described with reference to FIG. 5. The process of FIG. 5 is initiated in response to the user performing a predetermined operation to set the parking brake release operation to ON (YES in step S30).

Firstly in step S32, the controller 20 compares a detected pressure P1 detected by the hydraulic sensor 24 with a second pressure threshold Pth2. The second pressure threshold Pth2 at this time is a pressing force corresponding to the reaction force applied to the movable element 62 from the brake piston 56 when the parking brake is on. That is, if the detected pressure P1 reaches (is equal to or greater than) the second pressure threshold Pth2, the reaction force applied to the brake piston 56 is reduced or canceled. The second pressure threshold Pth2 is stored in advance in the controller 20. Strictly speaking, required second pressure threshold Pth2 changes based on the most-recently executed parking brake operation. Therefore, each time the controller 20 executes the parking brake operation, the controller 20 may determine and store a second pressure threshold Pth2 required for releasing the parking brake.

If determining that the detected pressure P1 is equal to or greater than the second pressure threshold Pth2 (YES in step S32), the controller 20 proceeds to step S34. On the other hand, if determining that the detected pressure P1 is less than the second pressure threshold Pth2 (NO in step S32), the controller 20 determines that the hydraulic pressure is insufficient and proceeds to step S42. In step S42, the controller 20 executes a notification process to the user. This notification process is the same as the above-described notification processes (steps S22 and S24 of FIG. 3), and is for encouraging the user to further operate the brake pedal 12. After having executed the notification process, the controller 20 returns to step S32.

In step S34, the controller 20 controls the motor 42 of the electric-powered system 40 to rotate in reverse. As a result, the lead screw 58 is rotated in reverse and the movable element 62 is moved away from the brake piston 56. At this time, the reaction force applied to the brake piston 56 by the parking brake operation has already been reduced or canceled by the hydraulic pressure. By the controller actuating the motor 42 in that state, the movable element 62 can surely be moved away from the brake piston 56. Then, the controller 20 proceeds to step S36.

In step S36, the controller 20 compares the current A1 of the motor 42 with a second current threshold Ath2. Based on this, the controller 20 determines whether or not the movable element 62 has come into contact with a stopper at its retraction limit position. That is, when the movable element 62 contacts the stopper at the retraction limit position and the motor 42 is thereby locked, the current A1 of the motor 42 increases significantly. As such, the controller 20 can determine that the movable element 62 has come into contact with the stopper when the current A1 of the motor 42 exceeds the second current threshold Ath2. If the current A1 of the motor 42 exceeds the second current threshold Ath2 (YES in step S36), the controller 20 proceeds to step S38. On the other hand, if the current A1 of the motor 42 is below the second current threshold Ath2 (NO in step S36), the controller 20 determines that the movable element 62 is not in contact with the stopper and repeats the process of step S36. The determination whether the movable element 62 has come into contact with the stopper (alternatively, the movable element 62 has moved sufficiently away from the brake piston 56) may be made based on indexes other than the current A1 of the motor 42.

In step S38, the controller 20 stops the motor 42. Then, in step S40, the user releases the operation on the brake pedal 12, by which the pressure in the hydraulic system 16 is decreased. At this time, the controller 20 may encourage the user to release the operation on the brake pedal 12 by notifying the user that the parking brake release operation has been completed. After the above, the parking brake release operation is terminated.

As can be understood from the foregoing description, in the parking brake release operation shown in FIG. 5, the pressing force required for releasing the parking brake is applied from the hydraulic system 16 to the brake piston 56 by the user operating the brake pedal 12. As such, during the parking brake release operation, the controller 20 encourages the user to further operate the brake pedal 12 by executing the above-described notification process when needed. As above, in the parking brake release operation shown in FIG. 5, the controller 20 does not directly control the operation of the hydraulic system 16 but indirectly controls the operation of the hydraulic system 16 by way of the operation performed by the user.

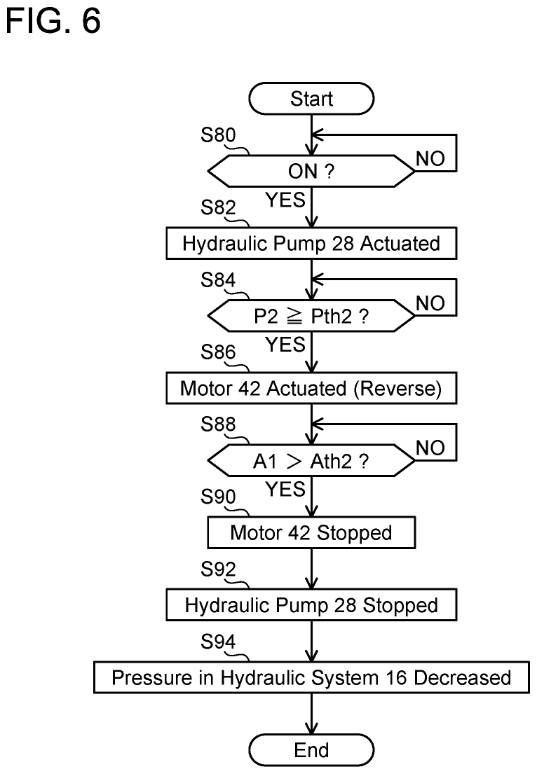

Another example of the parking brake release operation will be described with reference to FIG. 6. The process of FIG. 6 is initiated in response to the user performing the predetermined operation to set the parking brake release operation to ON (YES in step S80). Firstly, in step S82, the controller 20 actuates the hydraulic pump 28 of the hydraulic system 16.

Then, in step S84, the controller 20 compares the pump pressure P2 with the second pressure threshold Pth2. If determining that the pump pressure P2 is equal to or greater than the second pressure threshold Pth2 (YES in step S84), the controller 20 proceeds to step S86. On the other hand, if determining that the pump pressure P2 is less than the second pressure threshold Pth2 (NO in step S84), the controller 20 determines that the hydraulic pressure is insufficient and then executes the process of S84 again after a predetermined period of time elapses. In this parking brake release operation as well, the pump pressure P2 can be estimated, for example, based on the rotational speed of the hydraulic pump 28.

In step S86, the controller 20 controls the motor 42 of the electric-powered system 40 to rotate in reverse. This process is the same as the above-described process of step S34, that is, the lead screw 58 is rotated in reverse and the movable element 62 is moved away from the brake piston 56. At this time, the reaction force applied to the brake piston 56 by the parking brake operation has already been reduced or canceled by the hydraulic pressure. By the controller 20 actuating the motor 42 in that state, the movable element 62 can surely be moved away from the brake piston 56. Then, the controller 20 proceeds to step S88.

In step S88, the controller 20 compares the current A1 of the motor 42 with the second current threshold Ath2. This process is the same as the above-described process of step S36. If the current A1 of the motor 42 exceeds the second current threshold Ath2 (YES in step S88), the controller 20 determines that the movable element 52 has come into contact with the stopper at the retraction limit position and proceeds to step S90. On the other hand, if the current A1 of the motor 42 is below the second current threshold Ath2 (NO in step S88), the controller 20 determines that the movable element 62 is not in contact with the stopper and repeats the process of step S88. The determination whether the movable. element 62 has come into contact with the stopper (alternatively, the movable element 62 has moved sufficiently away from the brake piston 56) may be made based on indexes other than the current A1 of the motor 42.

In step S90, the controller 20 stops the motor 42. Then, in step S92, the controller 20 stops the hydraulic pump 28. After this, in step S94, the controller 20 decreases the pressure in the hydraulic system 16 by opening the first solenoid valve 30 and the third solenoid valve 34. After this, the parking brake release operation is terminated.

As can be understood from the foregoing description, in the parking brake release operation shown in FIG. 6, the pressing force required for releasing the parking brake is applied from the hydraulic system 15 to the brake piston 56 by the controller 20 directly controlling the operation of the hydraulic pump 28. Thus, the parking brake release operation can be executed without having have to particularly require the user to perform an operation.

In the above parking brake release operation, the actuation of the motor 42 (step S86) may be started immediately after the parking brake release operation was set to ON and may be executed in parallel to the pressure comparison (step S84). Alternatively, the hydraulic pump 28 may be stopped (step S92) simultaneously with or prior to the stopping of the motor 42 (step S90).

As described, the pump pressure P2 is a pressure supplied to the brake caliper 50 by operating the hydraulic pump 28. In the above parking brake release operation, the pump pressure, P2 may include a pressure generated by the user operating the brake pedal 12. In this case, the operation on the brake pedal 12 by the user is performed prior to the actuation of the hydraulic pump 28. As such, if the hydraulic pressure generated by the brake caliper 60 by the user operating the brake pedal 12 is insufficient, the hydraulic pump 28 can supplement the shortfall.

The parking brake operation disclosed herein may be executed every time the parking brake is used, or alternatively, it may be executed only when the parking brake is used in a particular situation. Examples of this particular situation include when a larger braking force than usual is required such as when the vehicle is parked on an inclined road surface like a sloped road, although it is not particularly limited thereto. Determination whether the vehicle is on the sloped road may be made, for example, by a G sensor installed in the vehicle, by a hydraulic pressure of a service brake in the parked vehicle, or by referring to information such as GPS location information.

In a variant of the art disclosed herein, the controller 20 may be provided with a stroke sensor configured to detect a stroke position of the brake piston 56. By referring to the stroke position, the controller 20 can determine that the braking force required for the parking brake operation is being applied to the braked member 52.

What is claimed is:

1. A brake device comprising:
a brake piston configured to press a braking member against a member to be braked rotating with a wheel;
a hydraulic system configured to press the brake piston toward the member to be braked;
an electric-powered system comprising a movable element configured to press the brake piston toward the member to be braked; and
a controller configured to execute a parking brake operation by using the hydraulic system and the electric-powered system,
wherein
in the parking brake operation, the controller is configured to apply a pressing force of a predetermined value or greater to the brake piston by using both the hydraulic system and the electric-powered system, and
the predetermined value is greater than a maximum pressing force that the electric-powered system is capable of applying to the brake piston.

2. The brake device according to claim 1, wherein
the electric-powered system comprises a lead screw configured to move the movable element toward and away from the brake piston and a motor configured to rotate the lead screw, and
in the parking brake operation, the controller is configured to control an operation of the motor.

3. The brake device according to claim 1, wherein
the hydraulic system is configured to change the pressing force applied to the brake piston based on an operation performed on a brake pedal by a user, and
in the parking brake operation, the controller is configured to execute a notification process for encouraging the user to further operate the brake pedal based on the pressing force applied to the brake piston by the hydraulic system.

4. The brake device according to claim 1, wherein
the hydraulic system comprises a hydraulic pump configured to increase the pressing force applied to the brake piston, and
in the parking brake operation, the controller is configured to control an operation of the hydraulic pump.

5. The brake device according to claim 1, wherein
the controller is configured to further execute a parking brake release operation by using the hydraulic system and the electric-powered system, and
in the parking brake release operation, the controller is configured to move the movable element of the electric-powered system away from the brake piston while applying the pressing force to the brake piston by the hydraulic system.
